(19) United States
(12) Patent Application Publication
(10) Pub. No.: US 2026/0155753 A1
(43) Pub. Date: Jun. 4, 2026

(54) POWER SUPPLY DEVICE AND POWER SUPPLY SYSTEM

(71) Applicant: Delta Electronics (Thailand) Public Company Limited, Samutprakarn (TH)

(72) Inventors: Yuesen Guo, Shanghai (CN); Donglin Fu, Shanghai (CN); Kai Dong, Shanghai (CN)

(21) Appl. No.: 19/396,858

(22) Filed: Nov. 21, 2025

(30) Foreign Application Priority Data
Dec. 3, 2024 (CN) 202411764050.7
Nov. 13, 2025 (CN) 202511661010.4

(51) Int. Cl. H02M 7/00; H02M 1/42; H02M 7/04

(52) U.S. Cl. CPC H02M 7/003; H02M 1/4241; H02M 1/4266; H02M 7/05

(57) ABSTRACT

A power supply device includes a main circuit board. The main circuit board includes a first side, a second side, a third side and a fourth side. The first side and the second side are opposed to each other and extended in a first direction. The third side and the fourth side are opposed to each other and extended in a second direction. An input/output module is located adjacent to the fourth side. A capacitor module is located adjacent to the third side. A rectifier module is disposed on the main circuit board. A rectifier module is arranged between the input/output module and the capacitor module and located adjacent to the input/output module. A first inductor module, a resonant module and a power semiconductor device module are disposed on the main circuit board and arranged between the capacitor module and the rectifier module.

### CROSS-REFERENCE TO RELATED APPLICATIONS

This application claims priorities to China Patent Application No. 202411764050.7 filed on Dec. 3, 2024, and China Patent Application No. 202511661010.4 filed on Nov. 13, 2025. The entire contents of the above-mentioned patent applications are incorporated herein by reference for all purposes.

### FIELD OF THE INVENTION

The present disclosure relates to the field of power electronics technology, and more particularly to a power supply device and a power supply system.

### BACKGROUND OF THE INVENTION

Nowadays, the trend in developing power supply devices is toward miniaturization and high power density. In the field of power supply devices, the spatial arrangement of various modules in the power supply device is usually suboptimal, resulting in low space utilization, elongated signal transmission paths, and excessive power losses. Due to the physical size constraints, it remains challenging to achieve a compact power supply architecture that simultaneously improves space utilization, shortens signal and power transmission paths, and enhances conversion efficiency.

Therefore, it is important to provide a power supply device and a power supply system in order to overcome the drawbacks of the conventional technologies.

### SUMMARY OF THE INVENTION

The present disclosure provides a power supply device and a power supply system. In the power supply device, a rectifier module is located adjacent to the input/output module, thereby shortening the output power paths. A first inductor module and a resonant module are located adjacent to a power semiconductor device module. Since the connection paths between the first inductor module and the power semiconductor device module and the connection paths between the resonant module and the power semiconductor device module are shortened, the space utilization of the power supply device is significantly improved. Furthermore, the signal transmission paths are optimized, and the efficiency is effectively improved. A bus connection plate is vertically inserted into the main circuit board and electrically connected to the capacitor module and the power semiconductor device module. Consequently, the connection paths between the capacitor module and the power semiconductor device module are shortened. Additionally, since the capacitor module is suspended from one side of the main circuit board, the required board area and material of the main circuit board are reduced, thereby saving the cost of the power supply device.

In accordance with an aspect of the present disclosure, a power supply device is provided. The power supply device includes a main circuit board, an input/output module, a capacitor module, a rectifier module, an EMI module, a first inductor module, a resonant module and a power semiconductor device module. The main circuit board includes a first side, a second side, a third side and a fourth side. The first side and the second side are opposed to each other and extended in a first direction. The third side and the fourth side are opposed to each other and extended in a second direction. The input/output module is disposed on the main circuit board and located adjacent to the fourth side of the main circuit board. The capacitor module is located adjacent to the third side of the main circuit board. The rectifier module is disposed on the main circuit board. The rectifier module is arranged between the input/output module and the capacitor module and located adjacent to the input/output module. The EMI module is disposed on the main circuit board and arranged between the capacitor module and the input/output module. The first inductor module, the resonant module and the power semiconductor device module are disposed on the main circuit board and arranged between the capacitor module and the rectifier module.

In accordance with another aspect of the present disclosure, a power supply system is provided. The power supply system includes at least one of the above-described power supply device and a liquid cooling plate. A plurality of protrusion structures and a plurality of glue filling grooves are disposed on at least one surface of the liquid cooling plate. The at least one surface of the liquid cooling plate where the plurality of protrusion structures and the plurality of glue filling grooves are disposed is attached to the at least one power supply device.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic block diagram illustrating the layout structure of a power supply device according to a first embodiment of the present disclosure;

FIG. 2 is a schematic circuit diagram illustrating the topology of a three-phase circuit of the power supply device shown in FIG. 1;

FIG. 3 is a schematic block diagram illustrating the layout structure of a power supply device according to a second embodiment of the present disclosure;

FIG. 4 is a schematic block diagram illustrating the layout structure of a power supply device according to a third embodiment of the present disclosure;

FIG. 5 is a schematic block diagram illustrating the layout structure of a power supply device according to a fourth embodiment of the present disclosure;

FIG. 6 is a schematic block diagram illustrating the layout structure of a power supply device according to a fifth embodiment of the present disclosure;

FIG. 7 is a schematic block diagram illustrating the layout structure of a power supply device according to a sixth embodiment of the present disclosure;

FIG. 8 is a schematic block diagram illustrating the layout structure of a power supply device according to a seventh embodiment of the present disclosure;

FIG. 9 is a schematic block diagram illustrating the layout structure of a power supply device according to an eighth embodiment of the present disclosure;

FIG. 10 is a schematic block diagram illustrating the layout structure of a power supply device according to a ninth embodiment of the present disclosure;

FIG. 11 is a schematic block diagram illustrating the layout structure of a power supply device according to a tenth embodiment of the present disclosure;

FIG. 12A is a schematic perspective view illustrating a power supply system according to a first embodiment of the present disclosure;

FIG. 12B is a schematic side view illustrating the power supply system shown in FIG. 12A;

FIG. 12C is a schematic exploded view illustrating the power supply system shown in FIG. 12A;

FIG. 13A is a schematic perspective view illustrating a power supply system according to a second embodiment of the present disclosure;

FIG. 13B is a schematic side view illustrating the power supply system shown in FIG. 13A;

FIG. 13C is a schematic exploded view illustrating the power supply system shown in FIG. 13A; and

FIG. 14 is a schematic block diagram illustrating the layout structure of a power supply device according to an eleventh embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The terms “including”, “comprising”, “having” and “containing” used in this context are all open terms, which mean including but not limited to. The following is a detailed description of some embodiments in conjunction with the attached figures. In the absence of conflict, the following embodiments and features in the embodiments may be combined with each other, and the same or similar concepts or processes may not be described in detail in some embodiments.

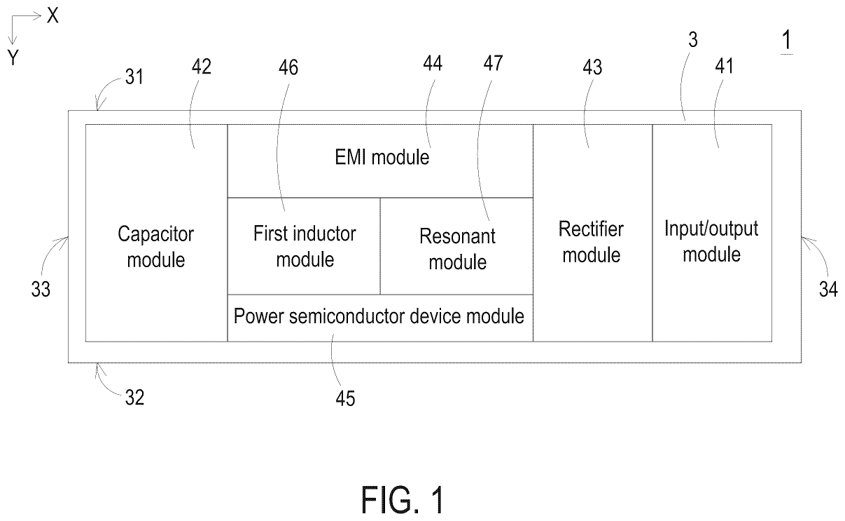

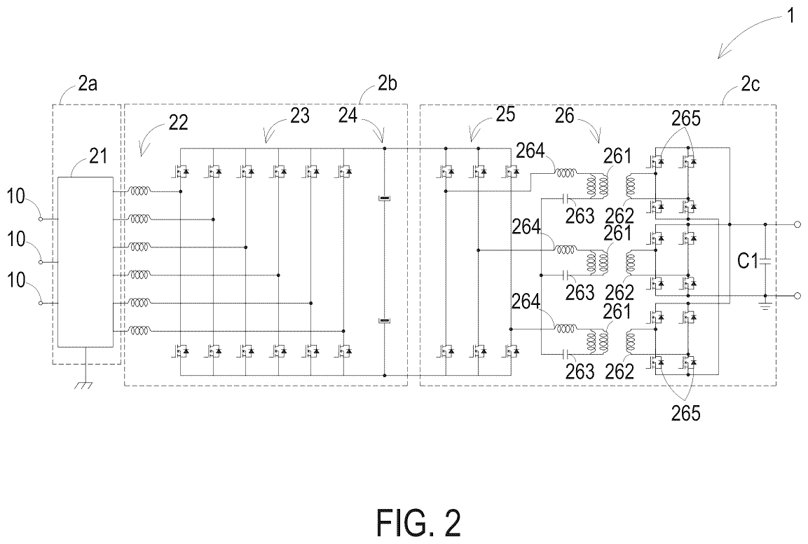

FIG. 1 is a schematic block diagram illustrating the layout structure of a power supply device according to a first embodiment of the present disclosure. FIG. 2 is a schematic circuit diagram illustrating the topology of a three-phase circuit of the power supply device shown in FIG. 1. The power supply device 1 receives AC power from an external power source and converts the AC power into a regulated voltage. The regulated voltage is provided to a load (not shown). In this embodiment, the circuit topology of the power supply device 1 includes three circuit modules, i.e., an EMI module 2a, a PFC module 2b and an LLC module 2c.

The EMI module 2a includes an EMI circuit 21. The EMI circuit 21 includes a common mode inductor (not shown), an X capacitor (not shown) and a Y capacitor (not shown). The X capacitor and the Y capacitor are safety capacitors. The EMI module 2a is used to eliminate electromagnetic interference in the circuit. The PFC module 2b includes a plurality of PFC inductors 22, a plurality of PFC power semiconductor switches 23 and two PFC output capacitors 24. The function of the PFC module 2b is to synchronize the input current waveform with the input voltage waveform, which improves the power factor. In the example of FIG. 2, the PFC module 2b includes a three-phase totem pole PFC topology. Each phase circuit includes two PFC inductors 22 and four PFC power semiconductor switches 23. In addition, the two PFC output capacitors 24 are shared by the three phase circuits of the three-phase totem pole PFC topology. Preferably but not exclusively, each of the PFC output capacitors 24 is a single capacitor or an equivalent capacitor of a plurality of capacitors. The LLC module 2c includes a plurality of LLC primary side power switches 25, a plurality of resonant capacitors 263, a plurality of resonant inductors 264, a plurality of transformers 261, a plurality of LLC secondary side rectifier switches 265 and an LLC output capacitor C1. Similarly, preferably but not exclusively, the LLC output capacitor C1 is a single capacitor or an equivalent capacitor of a plurality of capacitors.

Please refer to the circuity topology of FIG. 1 again. In this embodiment, the power supply device 1 includes a main circuit board 3, an input/output module 41, a capacitor module 42, a rectifier module 43, an EMI module 44, a power semiconductor device module 45, a first inductor module 46 and a resonant module 47.

Please refer to FIG. 1 and FIG. 2. The EMI module 2a in FIG. 2 corresponds to the EMI module 44 in FIG. 1. In addition, the EMI module 2a is connected to an input terminal 10. The input terminal 10 is disposed in the input/output module 41. As for the PFC module 2b, the PFC inductor 22 is disposed in the first inductor module 46, all PFC power semiconductor switches 23 are disposed in the power semiconductor device module 45, and the two PFC output capacitors 24 are disposed in the capacitor module 42. As for the LLC module 2c, the LLC primary side power switches 25 are disposed in the power semiconductor device module 45, the resonant inductors 264 and the resonant capacitors 263 are disposed in the resonant module 47, and the transformers 261, the LLC secondary side rectifier switches 265 and the LLC output capacitor C1 are disposed in the rectifier module 43. The LLC output capacitor C1 is connected to an output terminal 11. The output terminal 11 is disposed in the input/output module 41.

Structurally, the main circuit board 3 includes a first side 31, a second side 32, a third side 33 and a fourth side 34. The first side 31 and the second side 32 are opposed to each other and extended in a first direction X. The third side 33 and the fourth side 34 are arranged between the first side 31 and the second side 32. The third side 33 and the fourth side 34 are opposed to each other and extended in a second direction Y. The first direction X and the second direction Y are perpendicular to each other. For example, the first direction X is the X-axis direction, and the second direction Y is the Y-axis direction.

The input/output module 41 is disposed on the main circuit board 3 and located adjacent to the fourth side 34 of the main circuit board 3. The capacitor module 42 is located adjacent to the third side 33 of the main circuit board 3. The rectifier module 43 is disposed on the main circuit board 3 and arranged between the input/output module 41 and the capacitor module 42. In addition, the rectifier module 43 is closer to the input/output module 41 than the capacitor module 42. The EMI module 44 is disposed on the main circuit board 3 and arranged between the capacitor module 42 and the rectifier module 43. In addition, the EMI module 44 is located adjacent to the first side 31 of the main circuit board 3. The power semiconductor device module 45 is disposed on the main circuit board 3 and arranged between the capacitor module 42 and the rectifier module 43. In addition, the power semiconductor device module 45 is located adjacent to the second side 32 of the main circuit board 3. The first inductor module 46 is disposed on the main circuit board 3. The first inductor module 46 is arranged between the EMI module 44 and the power semiconductor device module 45 and arranged between the capacitor module 42 and the rectifier module 43. In addition, the first inductor module 46 is closer to the capacitor module 42 than the rectifier module 43. The resonant module 47 is disposed on the main circuit board 3. The resonant module 47 is arranged between the EMI module 44 and the power semiconductor device module 45 and arranged between the capacitor module 42 and the rectifier module 43. In addition, the resonant module 47 is closer to the rectifier module 43 than the capacitor module 42.

In the power supply device 1 of this embodiment, the first inductor module 46 and the resonant module 47 are arranged side by side and positioned adjacent to the power semiconductor device module 45. This configuration minimizes the connection paths between the first inductor module 46 and the power semiconductor device module 45 and the connection paths between the resonant module 47 and the power semiconductor device module 45, reducing power loss and improving space utilization of the power supply device 1.

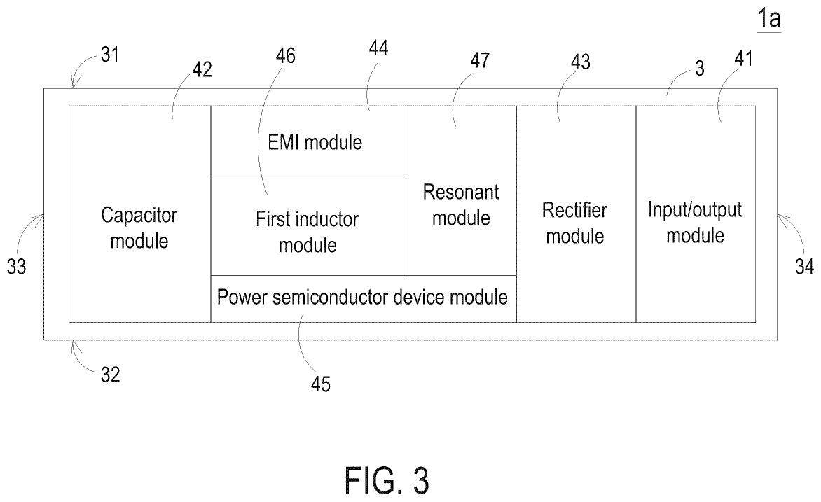

FIG. 3 is a schematic block diagram illustrating the layout structure of a power supply device according to a second embodiment of the present disclosure. Compared with the power supply device 1 of FIG. 1, the position of the resonant module 47 in the power supply device 1a of this embodiment is distinguished. In this embodiment, a portion of the resonant module 47 is arranged between the EMI module 44 and the rectifier module 43, and another portion of the resonant module 47 is arranged between the first inductor module 46 and the rectifier module 43. Due to the optimized circuit layout, the length of the resonant module 47 is reduced. That is, the length of the overall power supply device 1a is reduced. Compared with the first embodiment, the power supply device 1a of the second embodiment is applied to a wider and shorter main circuit board 3 more suitably.

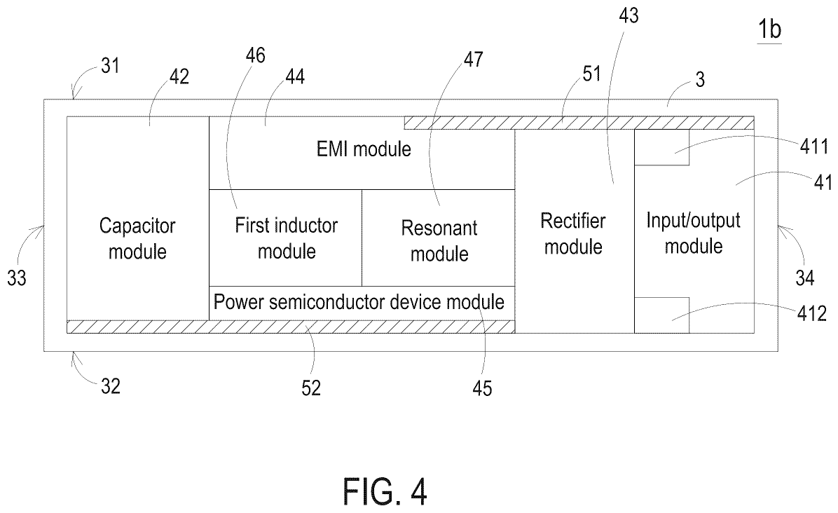

FIG. 4 is a schematic block diagram illustrating the layout structure of a power supply device according to a third embodiment of the present disclosure. Compared with the power supply device 1 of FIG. 1, the power supply device 1b of this embodiment further includes an input connection board 51 and a bus connection board 52. The input connection board 51 is vertically inserted into the first side 31 of the main circuit board 3 and connected to the main circuit board 3. In addition, the input/output module 41 and the EMI module 44 are connected to each other via the input connection board 51. Consequently, the input signal can be transmitted from the input/output module 41 to the EMI module 44 via the input connection board 51. The bus connection board 52 is vertically inserted into the second side 32 of the main circuit board 3 and connected to the main circuit board 3. In addition, the capacitor module 42 and the power semiconductor device module 45 are connected to each other via the bus connection board 52.

As mentioned above, the capacitor module 42 is located adjacent to the third side 33 of the main circuit board 3. The power switches in the power semiconductor device module 45 must be electrically connected to the capacitor module 42. In the high-power applications, the positive and negative terminals of the capacitor must be designed with a large copper cross-section to minimize resistive losses. Furthermore, a driver circuit (not shown) may be arranged around the power semiconductor devices. Due to the size constraint of the power supply device 1b, the bus connection board 52 enables a large copper area between the connection between the capacitors in the capacitor module 42 and the power semiconductor devices in the power semiconductor device module 45, thereby reducing the overall footprint of the power supply device. Furthermore, the lengths of the input connection board 51 and the bus connection board 52 are not constrained, as long as electrical connectivity to their respective components is maintained.

In this embodiment, the input signal is transferred via the input/output module 41, the input connection board 51, the EMI module 44, the first inductor module 46, the power semiconductor device module 45, the capacitor module 42, the resonant module 47, the rectifier module 43 and the input/output module 41 sequentially. Due to the above circuitry layout, the signal transmission paths between the input signal and the output signal are shortened, improving the space utilization and reducing the power loss.

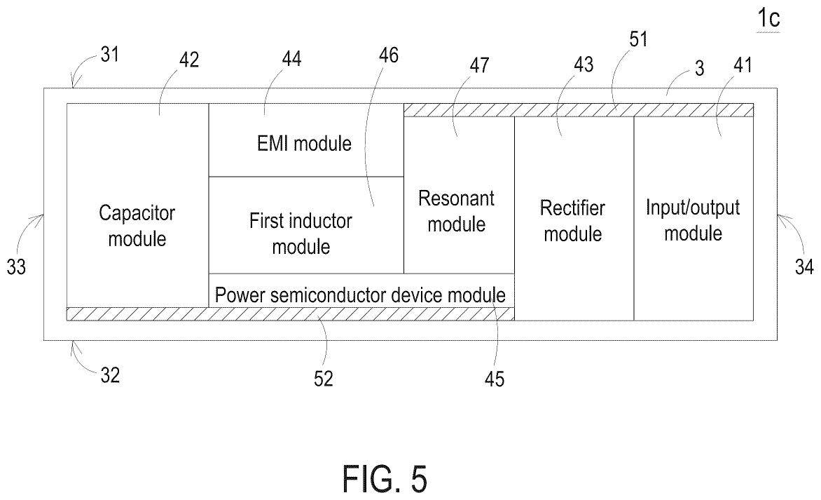

FIG. 5 is a schematic block diagram illustrating the layout structure of a power supply device according to a fourth embodiment of the present disclosure. Compared with the power supply device 1a of FIG. 3, the power supply device 1c of this embodiment further includes an input connection board 51 and a bus connection board 52. The input connection board 51 is vertically inserted into the first side 31 of the main circuit board 3 and connected to the main circuit board 3. In addition, the input/output module 41 and the EMI module 44 are connected to each other via the input connection board 51. Consequently, the input signal may be transmitted from the input/output module 41 to the EMI module 44 via the input connection board 51. The bus connection board 52 is vertically inserted into the second side 32 of the main circuit board 3 and connected to the main circuit board 3. In addition, the capacitor module 42 and the power semiconductor device module 45 are connected to each other via the bus connection board 52.

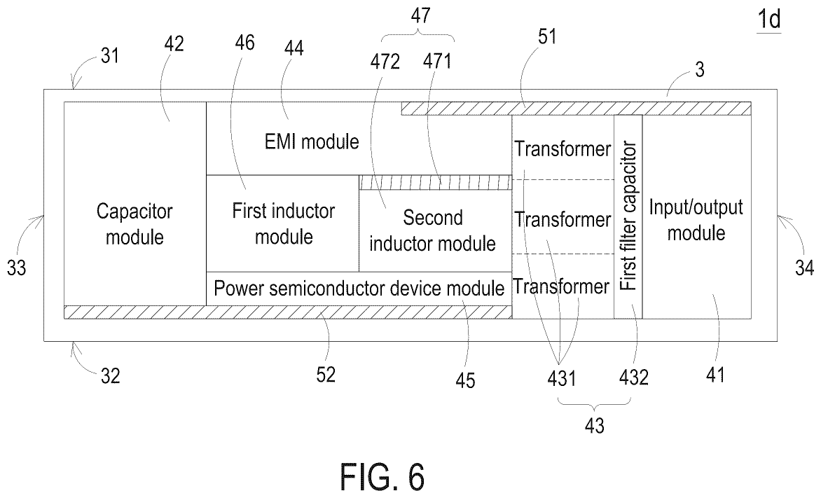

FIG. 6 is a schematic block diagram illustrating the layout structure of a power supply device according to a fifth embodiment of the present disclosure. Compared with the power supply device 1b of FIG. 4, the rectifier module 43 in the power supply device 1d of this embodiment includes three transformers 431 and at least one first filter capacitor 432. Each transformer 431 is connected to a rectifier switch set (not shown) for rectifying the output signal of the transformer 431. The three transformers 431 are disposed on the main circuit board 3 and sequentially arranged from the first side 31 to the second side 32 in the second direction Y. Due to the arrangement of the three transformers 431, the output paths of the rectifier module 43 are shortened. The first filter capacitor 432 is served as the LLC output capacitor C1 of the LLC module 2c shown in FIG. 2. It is noted that the number of the at least one first filter capacitor 432 is not restricted and can be adjusted according to the practical requirements.

In this embodiment, the resonant module 47 includes a resonant capacitor plate 471 and a second inductor module 472. The resonant capacitor plate 471 is vertically inserted into the main circuit board 3 and connected to the main circuit board 3. In addition, the resonant capacitor plate 471 is arranged between the second inductor module 472 and the EMI module 44. In this embodiment, a plurality of resonant capacitors may be disposed on the resonant capacitor plate 471, thereby further reducing the area occupied on the main circuit board 3. It is noted that the position of the resonant capacitor plate 471 may be adjusted according to the practical requirements. For example, in some other embodiments, the resonant capacitor plate 471 may be mounted adjacent to the first inductor module 46, mounted adjacent to the power semiconductor device module 45, or mounted adjacent to the transformers 431.

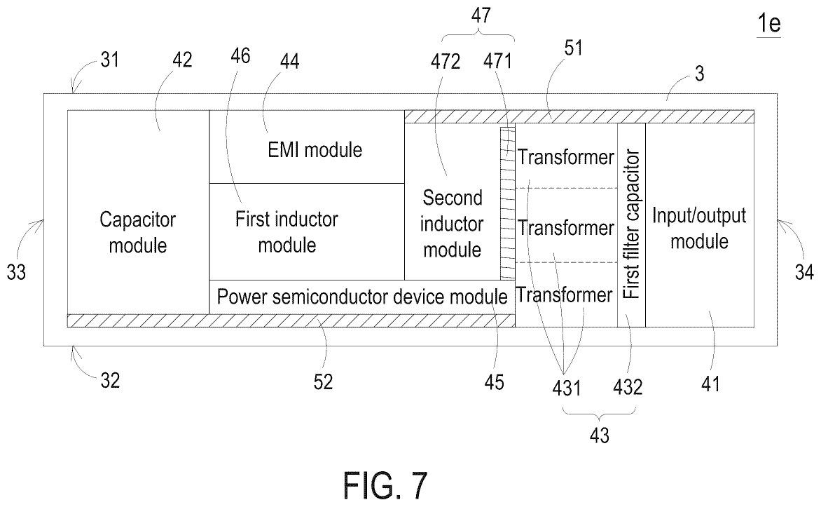

FIG. 7 is a schematic block diagram illustrating the layout structure of a power supply device according to a sixth embodiment of the present disclosure. Compared with the power supply device 1c of FIG. 5, the rectifier module 43 in the power supply device 1e of this embodiment includes three transformers 431 and at least one first filter capacitor 432. Each transformer 431 is connected to a rectifier switch set (not shown) for rectifying the output signal of the transformer 431. The three transformers 431 are disposed on the main circuit board 3 and sequentially arranged from the first side 31 to the second side 32 in the second direction Y. Due to the arrangement of the three transformers 431, the output paths of the rectifier module 43 are shortened. The first filter capacitor 432 is served as the LLC output capacitor C1 of the LLC module 2c shown in FIG. 2. The first filter capacitor 432 is arranged between the three transformers 431 and the input/output module 41. It is noted that the number of the at least one first filter capacitor 432 is not restricted and can be adjusted according to the practical requirements.

In this embodiment, the resonant module 47 includes a resonant capacitor plate 471 and a second inductor module 472. Similarly, a plurality of resonant capacitors are disposed on the resonant capacitor plate 471. The resonant capacitor plate 471 is connected to the main circuit board 3. Compared with the power supply device 1c of FIG. 5, the resonant capacitor plate 471 in the resonant module 47 of this embodiment is arranged between the second inductor module 472 and the rectifier module 43.

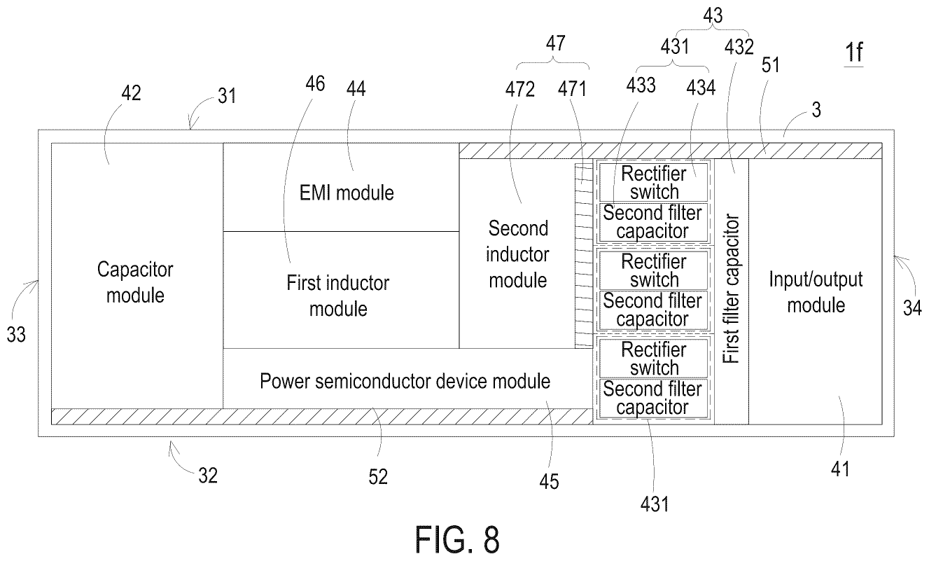

FIG. 8 is a schematic block diagram illustrating the layout structure of a power supply device according to a seventh embodiment of the present disclosure. Compared with the power supply device 1e of FIG. 7, the rectifier module 43 in the power supply device 1f of this embodiment further includes three second filter capacitors 433 and three rectifier switches 434. The three second filter capacitors 433 and the three rectifier switches 434 are arranged between the corresponding transformers 431 and the main circuit board 3. The three rectifier switches 434 are served as the LLC secondary side rectifier switches 265 shown in FIG. 2. The three second filter capacitors 433 and the first filter capacitor 432 are collaboratively formed as the LLC output capacitor C1 of the LLC module 2c shown in FIG. 2. Optionally, the rectifier module also includes a plurality of filter inductors (not shown). The filter inductors and the filter capacitors are collaboratively formed as a CLC filter circuit.

In a variant example of the power supply device 1b of FIG. 4, the capacitor module includes at least one capacitor connection plate and at least one energy storage capacitor. Of course, this variant example may be applied to other embodiments.

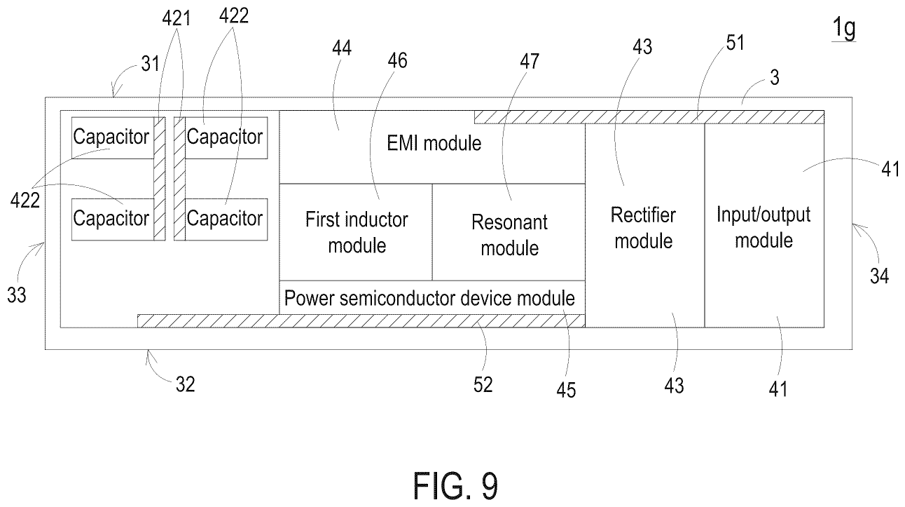

FIG. 9 is a schematic block diagram illustrating the layout structure of a power supply device according to an eighth embodiment of the present disclosure. Compared with the power supply device 1b of FIG. 4, the capacitor module 42 in power supply device 1g of this embodiment further includes two capacitor connection plates 421 and a plurality of energy storage capacitors 422. In case that the circuitry function is feasible, the number of the capacitor connection plates 421 and the number of the energy storage capacitors 422 are not restricted. The two capacitor connection plates 421 are vertically inserted into the main circuit board 3 and connected to the bus connection plate 52 via the main circuit board 3. Each energy storage capacitor 422 is mounted on the corresponding capacitor connection plate 421. In addition, the energy storage capacitor 422 is electrically connected to the power semiconductor device module 45 via the capacitor connection plate 421, the main circuit board 3 and the bus circuit board 52. In this way, the area occupied by the main circuit board 3 may be further reduced, and the signal transmission paths are optimized.

In some other embodiments, the capacitor module 42 and the main circuit board 3 are arranged along the first direction X.

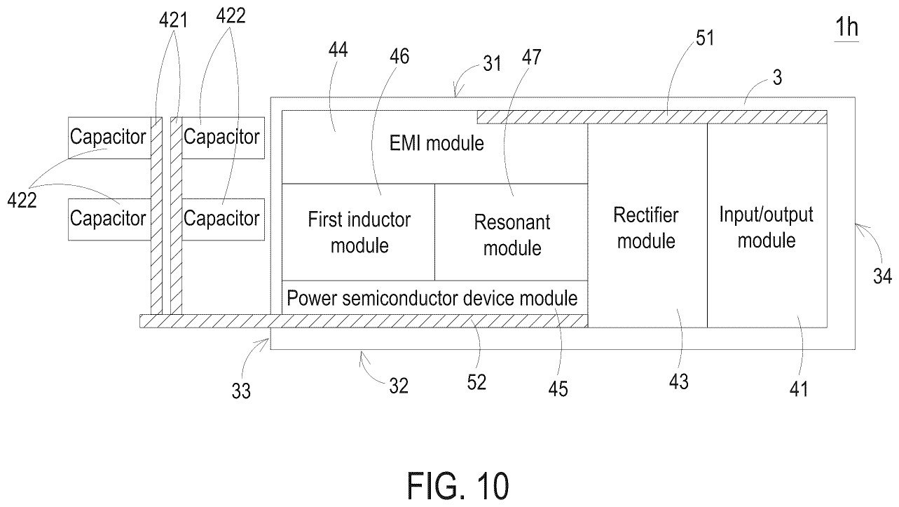

FIG. 10 is a schematic block diagram illustrating the layout structure of a power supply device according to a ninth embodiment of the present disclosure. Compared with the power supply device 1b of FIG. 4, the capacitor module 42 in power supply device 1h of this embodiment further includes two capacitor connection plates 421 and a plurality of energy storage capacitors 422. The two capacitor connection plates 421 are vertically inserted into the bus connection plate 52, respectively. Each energy storage capacitor 422 is mounted on the corresponding capacitor connection plate 421. In addition, the energy storage capacitor 422 is electrically connected to the power semiconductor device module 45 via the capacitor connection plate 421 and the bus circuit board 52.

In this embodiment, the energy storage capacitor 422 is not directly mounted on the main circuit board. Due to the reduced footprint of the main circuit board 3, the overall system size and installation cost are lowered. Of course, in a variant example, the energy storage capacitor 422 can be mounted on the main circuit board when the cost is not taken into account.

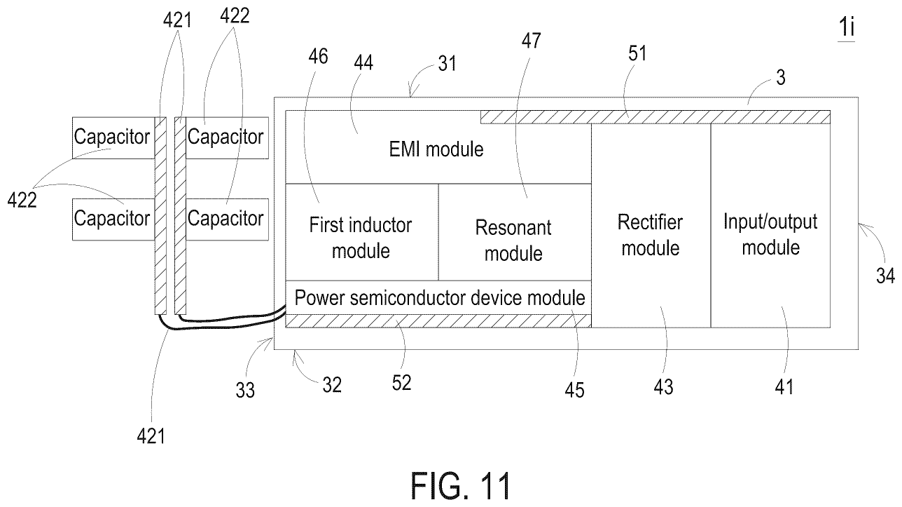

FIG. 11 is a schematic block diagram illustrating the layout structure of a power supply device according to a tenth embodiment of the present disclosure. Compared with the power supply device 1b of FIG. 4, the capacitor module 42 in power supply device 1i of this embodiment further includes two capacitor connection plates 421, a plurality of energy storage capacitors 422 and two conducting lines 423. The two capacitor connection plates 421 are electrically connected to the bus connection plate 52 via the corresponding conducting lines 423. Each energy storage capacitor 422 is mounted on the corresponding capacitor connection plate 421. In addition, the energy storage capacitor 422 is electrically connected to the power semiconductor device module 45 via the capacitor connection plate 421, the conducting lines 423 and the bus circuit board 52. In a variant example, the two conducting lines 423 are also electrically connected to the main circuit board 3.

In this embodiment, the energy storage capacitor 422 is not directly mounted on the main circuit board. Due to the reduced footprint t of the main circuit board 3 o, the overall system size and installation cost are lowered. Furthermore, due to the arrangement of the conducting lines 423, the wave soldering process is not required, thereby simplifying the manufacturing process.

Of course, in a variant example, the energy storage capacitor 422 can be mounted on the main circuit board when the cost is not taken into account. Furthermore, each of the power supply devices in the above embodiments can be applied to a power supply system with an air-cooling mechanism, a water-cooling mechanism or a mixed air/water cooling mechanism, but not limited thereto.

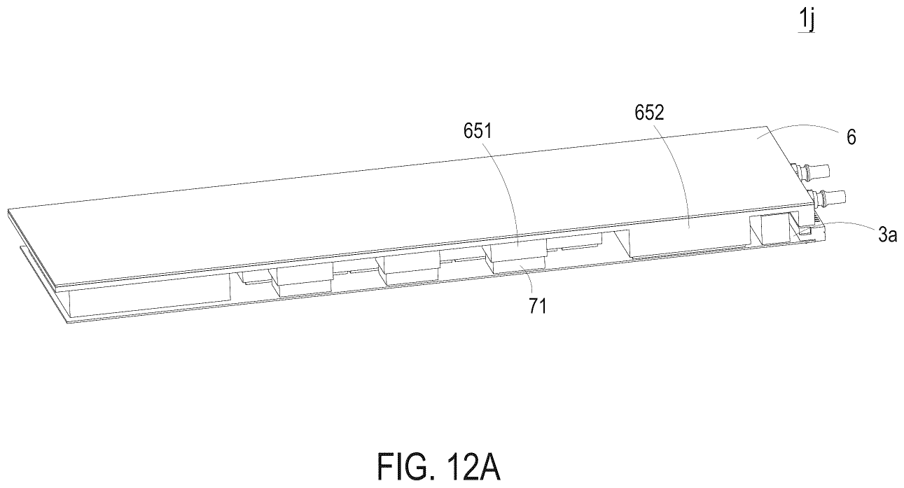

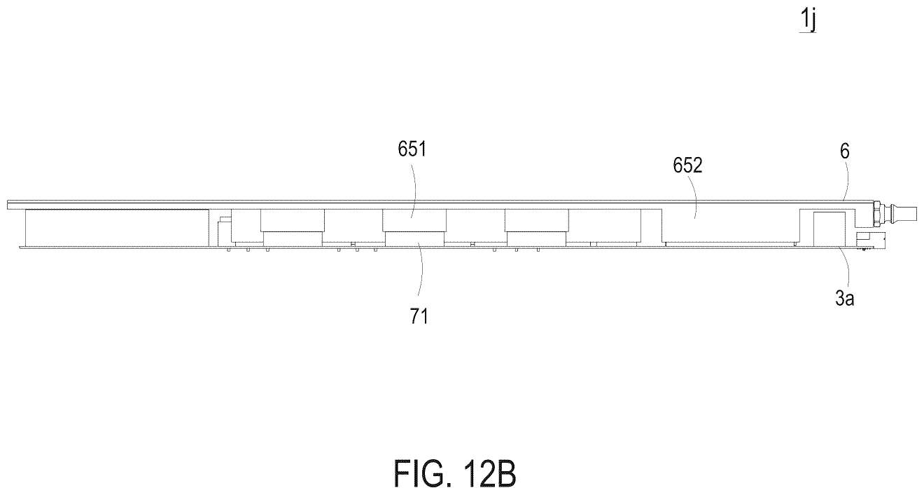

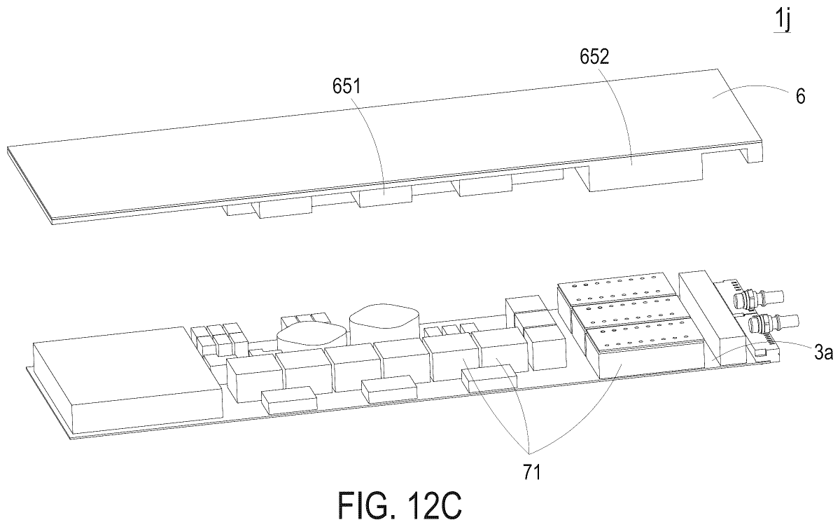

Please refer to FIGS. 12A, 12B and 12C. FIG. 12A is a schematic perspective view illustrating a power supply system according to a first embodiment of the present disclosure. FIG. 12B is a schematic side view illustrating the power supply system shown in FIG. 12A. FIG. 12C is a schematic exploded view illustrating the power supply system shown in FIG. 12A. In this embodiment, the power supply system 1j includes a single power supply device. For example, the power supply system 1j includes a main circuit board (e.g., a first main circuit board 3a), a plurality of first heat-generating components 71 and a liquid cooling plate 6. For example, the first heat-generating components 71 include the capacitor module 42, the rectifier module 43, the EMI module 44, the power semiconductor device module 45, the first inductor module 46 and the resonant module 47 shown in FIG. 1. The first heat-generating components 71 are disposed on the first main circuit board 3a. The liquid cooling plate 6 includes a plurality of protrusion structures 651 and a plurality of glue filling grooves 652. The plurality of protrusion structures 651 and the plurality of glue filling grooves 652 are disposed on the surface of the liquid cooling plate 6 facing the first main circuit board 3a. In addition, the plurality of protrusion structures 651 and the plurality of glue filling grooves 652 are in contact with the corresponding first heat-generating components 71 to remove the heat from the first heating elements 71.

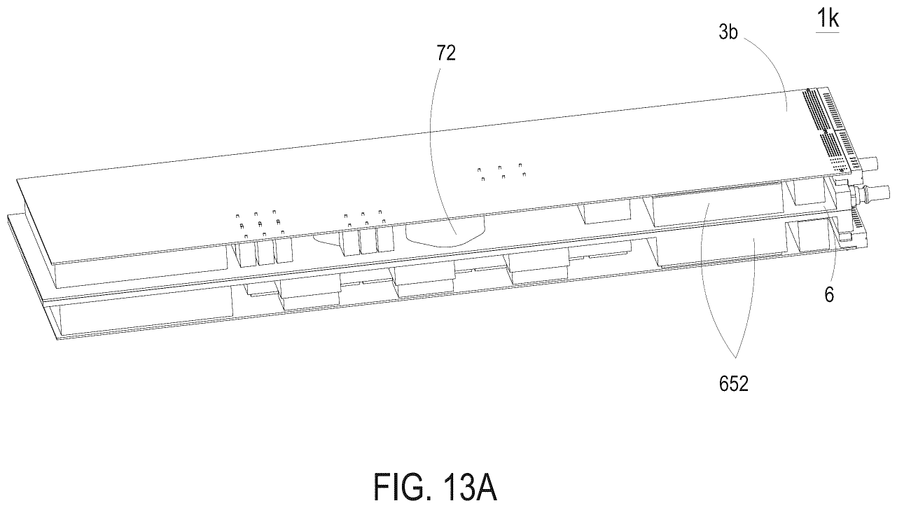

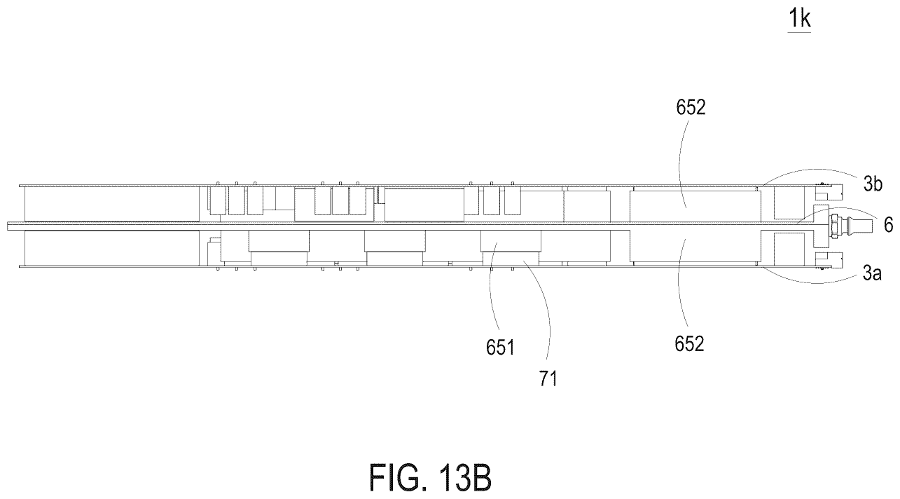

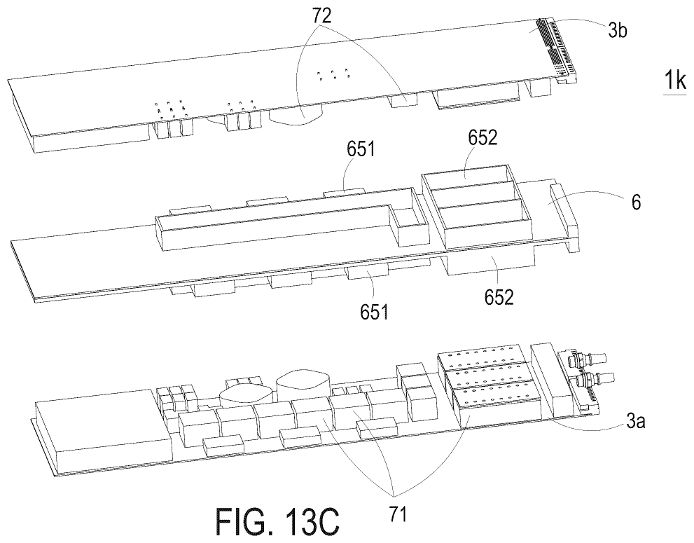

Please refer to FIGS. 13A, 13B and 13C. FIG. 13A is a schematic perspective view illustrating a power supply system according to a second embodiment of the present disclosure. FIG. 13B is a schematic side view illustrating the power supply system shown in FIG. 13A. FIG. 13C is a schematic exploded view illustrating the power supply system shown in FIG. 13A. In this embodiment, the power supply system 1k includes two power supply devices. For example, the power supply system 1k includes two main circuit boards (e.g., a first main circuit board 3a and a second main circuit board 3b), a plurality of first heat-generating components 71, a plurality of second heat-generating components 72 and a liquid cooling plate 6. The first main circuit board 3a and the second main circuit board 3b are opposed to each other with respect to the liquid cooling plate 6. That is, the power supply devices on two opposite sides of the liquid cooling plate 6 are individual power supply devices.

Similarly, the first heat-generating components 71 include the capacitor module 42, the rectifier module 43, the EMI module 44, the power semiconductor device module 45, the first inductor module 46 and the resonant module 47 shown in FIG. 1. The first heat-generating components 71 are disposed on the first main circuit board 3a. Similarly, the second heat-generating components 72 include the capacitor module 42, the rectifier module 43, the EMI module 44, the power semiconductor device module 45, the first inductor module 46 and the resonant module 47 shown in FIG. 1. The second heat-generating components 72 are disposed on the second main circuit board 3b. The plurality of first heat-generating components 71 and the plurality of second heat-generating components 72 are arranged between the first main circuit board 3a and the second main circuit board 3b.

The liquid cooling plate 6 is arranged between the first main circuit board 3a and the second main circuit board 3b. The liquid cooling plate 6 includes a plurality of protrusion structures 651 and a plurality of glue filling grooves 652. The plurality of protrusion structures 651 and the plurality of glue filling grooves 652 are disposed on two opposite sides of the liquid cooling plate 6. The protrusion structures 651 and the glue filling grooves 652 between the liquid cooling plate 6 and the first main circuit board 3a are in contact with the corresponding first heat-generating components 71 to remove the heat from the first heat-generating components 71. The protrusion structures 651 and the glue filling grooves 652 between the liquid cooling plate 6 and the second main circuit board 3b are in contact with the corresponding second heat-generating components 72 to remove the heat from the second heat-generating components 72.

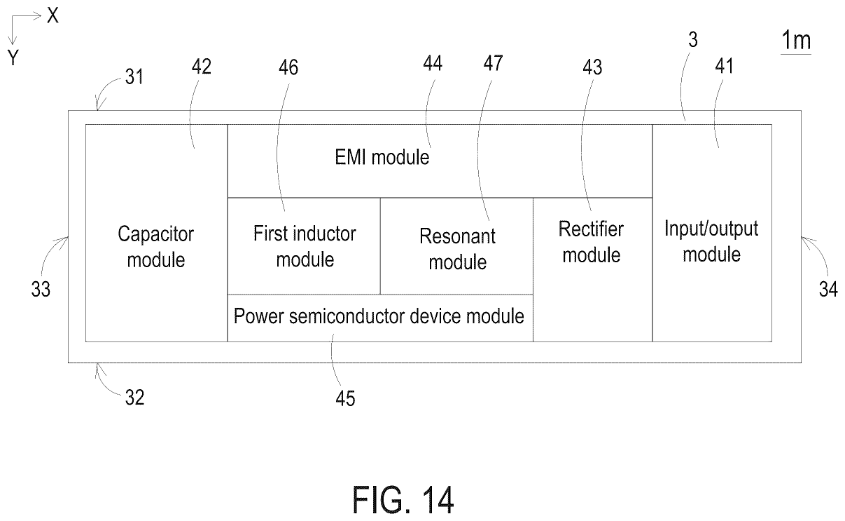

FIG. 14 is a schematic block diagram illustrating the layout structure of a power supply device according to an eleventh embodiment of the present disclosure. The input/output module 41 of the power supply device 1m is disposed on the main circuit board 3 and located adjacent to the fourth side 34 of the main circuit board 3. The capacitor module 42 is located adjacent to the third side 33 of the main circuit board 3. The rectifier module 43 is disposed on the main circuit board 3 and arranged between the input/output module 41 and the capacitor module 42. In addition, the rectifier module 43 is closer to the input/output module 41 than the capacitor module 42. The EMI module 44 is disposed on the main circuit board 3 and arranged between the capacitor module 42 and the input/output module 41. In addition, the EMI module 44 is located adjacent to the first side 31 of the main circuit board 3. The power semiconductor device module 45 is disposed on the main circuit board 3 and arranged between the capacitor module 42 and the rectifier module 43. In addition, the power semiconductor device module 45 is located adjacent to the second side 32 of the main circuit board 3. The first inductor module 46 is disposed on the main circuit board 3. The first inductor module 46 is arranged between the EMI module 44 and the power semiconductor device module 45 and arranged between the capacitor module 42 and the rectifier module 43. In addition, the first inductor module 46 is closer to the capacitor module 42 than the rectifier module 43. The resonant module 47 is disposed on the main circuit board 3. The resonant module 47 is arranged between the EMI module 44 and the power semiconductor device module 45 and arranged between the capacitor module 42 and the rectifier module 43. In addition, the resonant module 47 is closer to the rectifier module 43 than the capacitor module 42.

From the above descriptions, the present disclosure provides the power supply device. The EMI module is arranged between the capacitor module and the input/output module. The first inductor module, the resonant module and the power semiconductor device module are arranged between the capacitor module and the rectifier module. The first inductor module and the resonant module are located adjacent to the power semiconductor device module. By shortening the connection paths between the first inductor module and the power semiconductor device module, and between the resonant module and the power semiconductor device module, the space utilization of the power supply device is enhanced, the signal transmission paths are optimized, and the efficiency is effectively increased.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply device, comprising:
a main circuit board comprising a first side, a second side, a third side and a fourth side, wherein the first side and the second side are opposed to each other and extend in a first direction, and the third side and the fourth side are opposed to each other and extend in a second direction;
an input/output module disposed on the main circuit board and adjacent to the fourth side of the main circuit board;
a capacitor module located adjacent to the third side of the main circuit board;
a rectifier module disposed on the main circuit board, wherein the rectifier module is arranged between the input/output module and the capacitor module and adjacent to the input/output module;
an EMI module disposed on the main circuit board and arranged between the capacitor module and the input/output module; and
a first inductor module, a resonant module and a power semiconductor device module disposed on the main circuit board and arranged between the capacitor module and the rectifier module.

2. The power supply device according to claim 1, wherein the EMI module is located adjacent to the first side of the main circuit board, the power semiconductor device module is located adjacent to the second side of the main circuit board, and the first inductor module and the resonant module are arranged between the EMI module and the power semiconductor device module, wherein the first inductor module is located adjacent to the capacitor module, and the resonant module is located adjacent to the rectifier module.

3. The power supply device according to claim 1, wherein the EMI module is located adjacent to the first side of the main circuit board and located between the capacitor module and the input/output module, the power semiconductor device module is located adjacent to the second side of the main circuit board, and the first inductor module is arranged between the EMI module and the power semiconductor device module and located adjacent to the capacitor module, wherein a portion of the resonant module is arranged between the EMI module and the rectifier module, and another portion of the resonant module is arranged between the first inductor module and the rectifier module.

4. The power supply device according to claim 1, wherein the power supply device further comprises an input connection board, wherein the input connection board is located on the first side of the main circuit board and connected to the main circuit board, and an input signal is transmitted from the input/output module to the EMI module via the input connection board.

5. The power supply device according to claim 1, wherein the power supply device further comprises a bus connection board, wherein the bus connection board is located on the second side of the main circuit board and connected to the main circuit board, and the capacitor module and the power semiconductor device module are connected to each other via the bus connection board.

6. The power supply device according to claim 1, wherein the rectifier module comprises at least one transformer, at least one filter capacitor and a plurality of rectifier switches, wherein the at least one transformer is arranged from the first side of the main circuit board to the second side of the main circuit board in the second direction.

7. The power supply device according to claim 6, wherein the at least one filter capacitor comprises at least one first filter capacitor, and the at least one first filter capacitor is arranged between the at least one transformer and the input/output module.

8. The power supply device according to claim 7, wherein the at least one filter capacitor further comprises at least one second filter capacitor, and the at least one second filter capacitor and the plurality of rectifier switches are arranged between the corresponding transformers and the main circuit board.

9. The power supply device according to claim 1, wherein the resonant module comprises a resonant capacitor plate and a second inductor module, wherein the resonant capacitor plate comprises a plurality of resonant capacitors, and the resonant capacitor plate is connected to the main circuit board.

10. Power supply device according to claim 9, wherein the resonant capacitor plate is arranged between the second inductor module and the EMI module.

11. The power supply device according to claim 9, wherein the resonant capacitor plate is arranged between the second inductor module and the rectifier module.

12. The power supply device according to claim 1, wherein the capacitor module includes at least one capacitor connection plate and a plurality of energy storage capacitors, wherein each of the plurality of energy storage capacitors is inserted into the corresponding capacitor connection plate and electrically connected to the power semiconductor device module.

13. The power supply device according to claim 12, wherein the capacitor module is disposed on the main circuit board, and the at least one capacitor connection plate is vertically connected to the main circuit board.

14. The power supply device according to claim 12, wherein the at least one capacitor connection plate is connected to a bus connection plate and electrically connected to the power semiconductor device module, wherein the bus connection plate is connected to the main circuit board and located on the second side of the main circuit board.

15. The power supply device according to claim 12, wherein the capacitor module further includes at least one conducting line, and the at least one capacitor connection plate is electrically connected to the power semiconductor device module via the corresponding conducting line.

16. The power supply device according to claim 1, wherein the input/output module includes an input terminal and an output terminal, wherein the input terminal is connected to the EMI module, and the output terminal is connected to the rectifier module.

17. The power supply device according to claim 1, wherein the first inductor module and a portion of the power semiconductor device module are collaboratively formed as a PFC circuit, and the resonant module, another portion of the power semiconductor device module and the rectifier module are collaboratively formed as an LLC circuit.

18. A power supply system, comprising:
at least one power supply device, wherein each of the at least one power supply device comprises:
a main circuit board comprising a first side, a second side, a third side and a fourth side, wherein the first side and the second side are opposed to each other and extended in a first direction, and the third side and the fourth side are opposed to each other and extended in a second direction;
an input/output module disposed on the main circuit board and located adjacent to the fourth side of the main circuit board;
a capacitor module located adjacent to the third side of the main circuit board;
a rectifier module disposed on the main circuit board, wherein the rectifier module is arranged between the input/output module and the capacitor module and located adjacent to the input/output module; and
an EMI module, a first inductor module, a resonant module and a power semiconductor device moule disposed on the main circuit board and arranged between the capacitor module and the rectifier module; and
a liquid cooling plate, wherein a plurality of protrusion structures and a plurality of glue filling grooves are disposed on at least one surface of the liquid cooling plate,
wherein the at least one surface of the liquid cooling plate where the plurality of protrusion structures and the plurality of glue filling grooves are disposed is attached to the at least one power supply device.

19. The power supply system according to claim 18, wherein the plurality of protrusion structures and the plurality of glue filling grooves are in contact with corresponding heat-generating components in the at least one power supply device.
